(19) United States
(12) Patent Application Publication
(10) Pub. No.: US 2009/0005022 A1
(43) Pub. Date: Jan. 1, 2009

(54) Methods, Apparatuses and Computer Program Products for Providing a Party Defined Theme

(75) Inventors: Arto Lehtiniemi, Lempaala (FI); Antti Eronen, Tampere (FI); Jukka A. Holm, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/771,050

(22) Filed: Jun. 29, 2007

(51) Int. Cl. H04M 3/42

(52) U.S. Cl. 455/415

(57) ABSTRACT

An apparatus for providing a party defined theme may include a processing element. The processing element may be configured to receive an indication of a communication between parties comprising an initiator and a receiver of the communication, identify theme information associated with and defined by one of the parties, and render the identified theme information at the other of the parties in response to receipt of the indication.

### TECHNOLOGICAL FIELD

Embodiments of the present invention relate generally to mobile communication technology and, more particularly, relate to methods, apparatuses and computer program products for providing a party defined theme to a receiving device.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to further improve the ease of information transfer and convenience to users involves the provision of calling features. Call annunciation is an example of such a feature. It is currently common for mobile terminals, such as mobile telephones, to offer various different ringing tones which may be selected by users of the mobile terminals according to individual preferences. However, beyond the provision of conventional audio ringing tones, there is a current demand to provide more personalized calling features including call annunciation. In this regard, methods have been proposed in which, when a mobile terminal receives a call from a particular caller that is associated with an image, the image may be displayed to alert the user of the mobile terminal of the call.

However, call annunciation is just one area of calling features for which there is a demand to improve the ability of a user to personalize his or her mobile terminal. In this regard, there has been an interest among mobile terminal users to utilize covers, ringtones, themes and software related upgrades to express ones personality, mood and/or feelings. However, such expression has typically been limited to expression on the user's own device. Similarly, the call annunciation mechanisms described above typically require the content used for alerting the user to be located at the mobile terminal receiving the call. Thus, personalized call annunciation typically relates to personalization performed by the receiver of the call and the caller is limited in ability to personalize the annunciation of his or her calls made to other individuals. For example, the receiver of the call may define particular media stored at the mobile terminal to be played to announce receipt of a particular call. Additionally, certain methods may enable a receiver of the call to access media specified in a message, which could be used for annunciating a call. However, such methods require increased network resource consumption and setup times. Moreover, personalization of call annunciation and/or personalizing in-call features by, for example, providing caller defined themes, is currently not available.

Accordingly, it may be advantageous to provide users with improved personalization tools, which may overcome at least some of the disadvantages described above.

### BRIEF SUMMARY

A method, apparatus and computer program product are therefore provided to enable a caller defined theme to be provided to a receiving device. In particular, a method, apparatus and computer program product are provided to enable, for example, a caller to define a user interface scheme and audio features to be rendered at a device of a receiver of a call. In this regard, the appearance of features, applications, links and/or other characteristics of the receiver's device may be altered in accordance with audio and/or visual theme information received from and defined by the caller either in real time during a call or prior to the call. As such, the caller may define characteristics of the receiver's idle screen and/or characteristics of various applications of the receiver. Similarly, a receiver may define theme information for rendering at the caller's device in response to receipt of an indication of the call. Accordingly, user experience may be enhanced by enabling users to communicate personalized themes to other users.

In one exemplary embodiment, a method of providing a party defined theme is provided. The method may include receiving an indication of a communication between parties comprising an initiator and receiver of the communication, identifying theme information associated with and defined by one of the parties, and, in response to receipt of the indication, rendering the identified theme information at the other of the parties.

In another exemplary embodiment, a computer program product for providing a party defined theme is provided. The computer program product includes at least one computer-readable storage medium having computer-readable program code portions stored therein. The computer-readable program code portions include first, second and third executable portions. The first executable portion is for receiving an indication of a communication between parties comprising an initiator and receiver of the communication. The second executable portion is for identifying theme information associated with and defined by one of the parties. The third executable portion is for, in response to receipt of the indication, rendering the identified theme information at the other of the parties.

In another exemplary embodiment, an apparatus for providing a party defined theme is provided. The apparatus may include a processing element. The processing element may be configured to receive an indication of a communication between parties comprising an initiator and a receiver of the communication, identify theme information associated with and defined by one of the parties, and render the identified theme information at the other of the parties in response to receipt of the indication.

In another exemplary embodiment, an apparatus for providing a party defined theme is provided. The apparatus may include means for receiving an indication of a communication between parties comprising an initiator and receiver of the communication, means for identifying theme information associated with and defined by one of the parties and means for, in response to receipt of the indication, rendering the identified theme information at the other of the parties.

Embodiments of the invention may provide a method, apparatus and computer program product for employment in systems to enhance user experience during mobile communications. As a result, for example, users may benefit from using mobile terminals and other electronic devices with improved ability to express themselves to others.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of a system for providing a party defined theme according to an exemplary embodiment of the present invention;

FIG. 4 illustrates a display of a device rendering a party defined theme according to an exemplary embodiment of the present invention; and

FIG. 5 is a flowchart according to an exemplary method for providing a party defined theme according to another exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

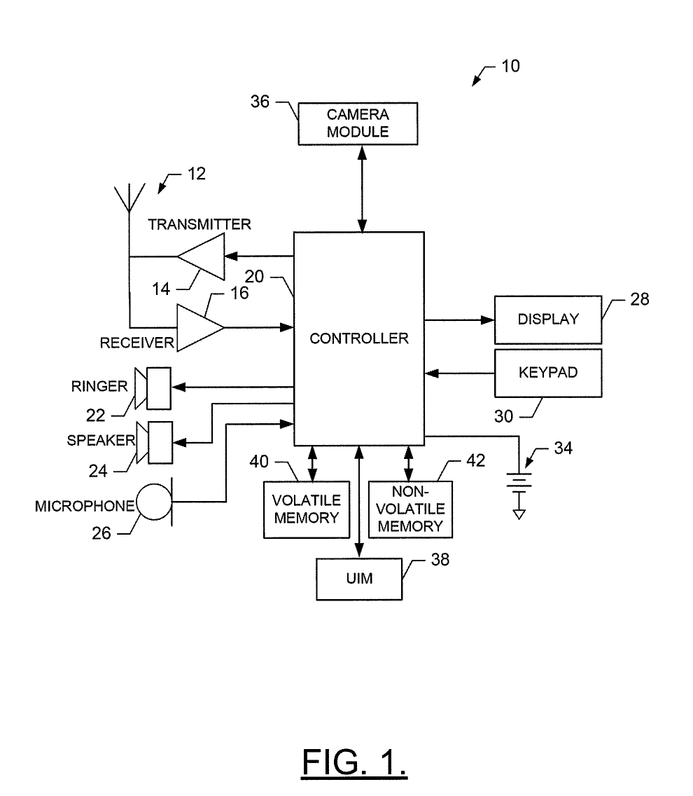

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 may include a media capturing element, such as a camera, video and/or audio module, in communication with the controller 20. The media capturing element may be any means for capturing an image, video and/or audio for storage, display or transmission. For example, in an exemplary embodiment in which the media capturing element is a camera module 36, the camera module 36 may include a digital camera capable of forming a digital image file from a captured image. As such, the camera module 36 includes all hardware, such as a lens or other optical component(s), and software necessary for creating a digital image file from a captured image. Alternatively, the camera module 36 may include only the hardware needed to view an image, while a memory device of the mobile terminal 10 stores instructions for execution by the controller 20 in the form of software necessary to create a digital image file from a captured image. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to a JPEG standard format.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

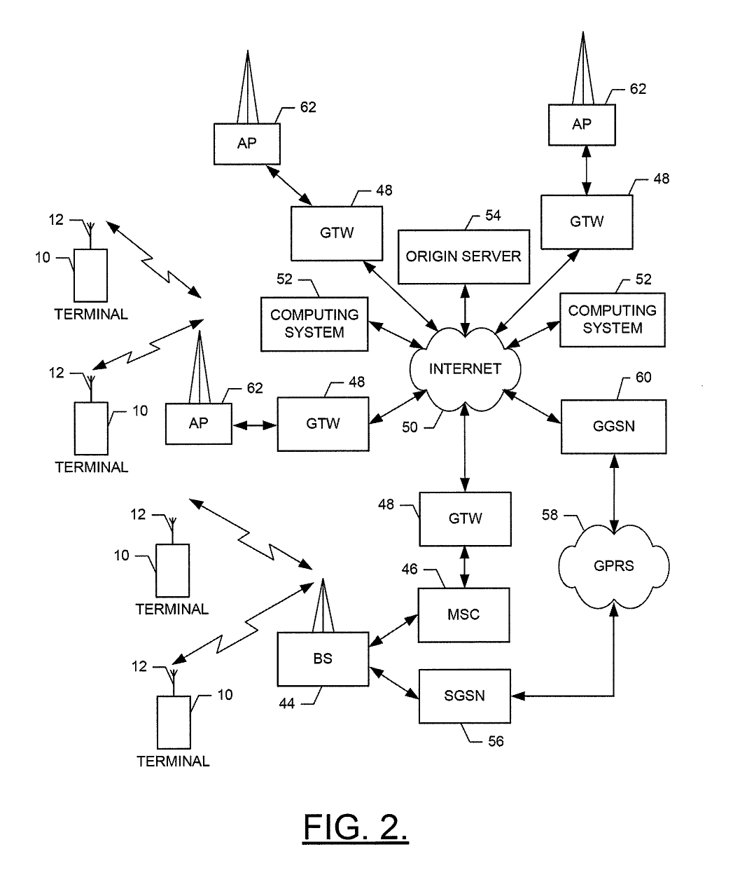

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1 and a network device of the system of FIG. 2 in order to execute applications for establishing communication between the mobile terminal 10 and other mobile terminals, for example, via the system of FIG. 2. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a network device such as a server or other device accessible to the communication device.

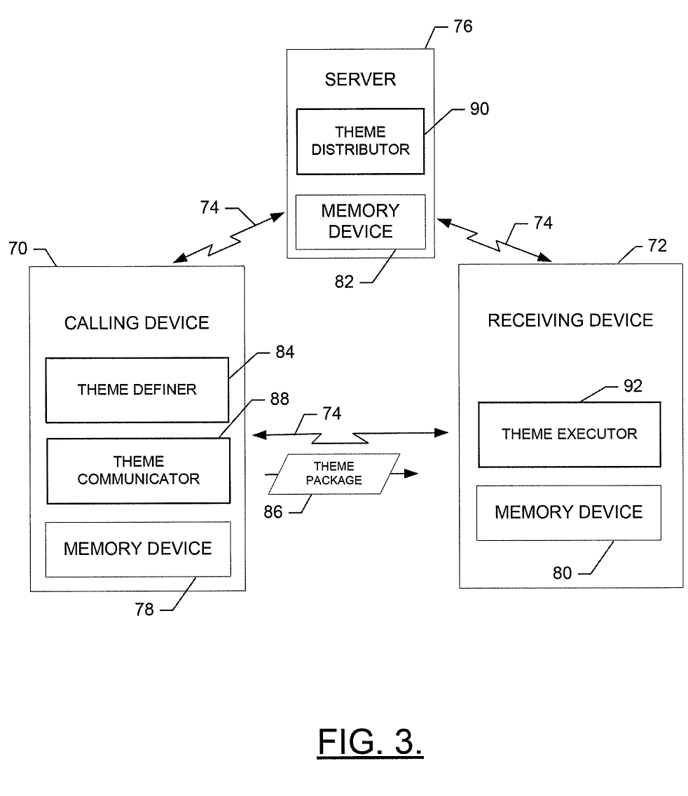

FIG. 3 illustrates a block diagram of a system for providing caller defined themes according to an exemplary embodiment of the present invention. The system of FIG. 3 will be described, for purposes of example, in connection with the mobile terminal 10 of FIG. 1. However, it should be noted that the system of FIG. 3, may also be employed in connection with a variety of other devices, both mobile and fixed, and therefore, embodiments of the present invention should not be limited to application on devices such as the mobile terminal 10 of FIG. 1. It should also be noted, that while FIG. 3 illustrates one example of a configuration of a system for providing a caller defined theme, numerous other configurations may also be used to implement embodiments of the present invention. Additionally, it should be noted that embodiments of the present invention do not necessarily communicate multimedia from one mobile terminal to another, but may instead merely enable a caller to alter the theme rendered at a device of a receiver of a call.

Referring now to FIG. 3, a basic block diagram of a system for providing a caller defined theme is provided. As indicated in FIG. 3, the system may include a calling device 70 and a receiving device 72, which may be capable of communication with each other via communication links 74. It should be understood that the communication links 74 may be provided by any suitable mechanism such as, for example, by the system of FIG. 2. In other words, in one exemplary embodiment, the calling device 70 and the receiving device 72 may each be mobile terminals (e.g., the mobile terminal 10) in communication via a cellular network. In an exemplary embodiment, the system may further include a server 76, which may be a device of the system of FIG. 2. The server 76 may be capable of communication with the calling device 70 and/or the receiving device 72 via the communication links 74. Each of the calling device 70, the receiving device 72 and the server 76 may include a corresponding memory device (e.g., memory device 78, memory device 80 and memory device 82, respectively).

Embodiments of the present invention may provide the calling device 70 with the ability to personalize a theme that may be rendered at the receiving device 72 during an active call. In other words, the theme may be rendered at the receiving device 72 to announce a call and/or during any or all portions of the call. In this regard, the calling device 70 may either communicate theme information directly to the receiving device 72 via the communication links 74 (either before or during a current active call), or the calling device 70 may communicate the theme information to the receiving device 72 indirectly via the server 76 or another device via the communication links 74.

Theme information may include information defining the user interface scheme and audio of a device such as, for example, the mobile terminal 10. As such, theme information may include executable instructions that define graphics, sound alerts, lighting effects and/or mechanical effects for the device. For example, LEDs, vibrating, motorized or other miscellaneous moving parts of the mobile terminal 10 may be manipulated in accordance with the theme information. Accordingly, theme information is not limited to application with idle screen, interface background and/or ring tone sounds and appearances. Rather, the theme information may define a set of user interface graphics and device sounds that provide the user (or caller in exemplary embodiments) with the ability to personalize the look and sound of the recipient's device. In this regard, by utilizing theme information, the user may change or customize the visual appearance and audio rendering of numerous applications executable by the device. Such applications are not necessarily limited to applications associated with the idle screen, but may also include other applications such as built-in applications (e.g., a calendar application and the like). In this regard, the theme information, rather than defining multimedia to be rendered at the device, may modify elements of the user interface and audio of the device employing the theme information. Examples of elements that may be modified via the theme information may include, without limitation, ring tone, wallpaper, screen saver, color scheme, menu background, user interface areas such as status, list and column areas, icons such as application list and note icons, highlights on list, grid and input areas, pop-up windows, system indicators such as volume, tab, signal strength, battery charge, navigation and wait/progress bar indicators, elements of the telephone application (idle), calendar, pinboard, and settings applications such as backgrounds, color scheme, and other sounds such as message alerts. Adaptive cover material could also be manipulated via the theme information.

In an exemplary embodiment, the calling device 70 may include a theme definer 84, which may be any device or means embodied in either hardware, software, or a combination of hardware and software that is configured to define theme information into a particular theme package 86. The theme definer 84 may be embodied as, or otherwise controlled by a processing element (e.g., the controller 20) of the calling device 70. Processing elements as described herein may be embodied in many ways. For example, the processing element may be embodied as a processor, a coprocessor, a controller or various other processing means or devices including integrated circuits such as, for example, an ASIC (application specific integrated circuit). The theme definer 84 may present a user of the calling device 70 with various options, such as via a menu, list or other format, that may be manipulated or selected by a user interface of the calling device 70 for defining theme information for the theme package 86. The theme package 86 may be stored in the memory device 78 of the calling device 70 and, for example, if activated, selected or otherwise executed at the calling device 70, the theme information of the theme package 86 may modify elements of the user interface and/or audio of the calling device 70. However, as will be seen below, the theme package 86 may also be communicated to other devices for execution at another device such as the receiving device 72.

The calling device 70 may also include a theme communicator 88, which may be any device or means embodied in either hardware, software, or a combination of hardware and software that is configured to communicate the theme package 86 to another device such as, for example, the server 76 or the receiving device 72. In this regard, the theme communicator 88, which may be controlled by or otherwise embodied as the processing element of the calling device 70, may, for example, packetize the theme package 86 for communication via the communication links 74. As such, the theme communicator 88 may be configured to enable streaming of the theme package 86, for example, for real-time execution of the theme information at the receiving device 72 during an active call, or the theme communicator 88 may be configured to communicate the theme package 86 to either the receiving device 72 or the server 76 for storage via a bursty communication mechanism using the communication links 74.

In embodiments where the server 76 stores theme information, numerous collections of theme information (perhaps for numerous different users or devices) may be stored in the form of separate theme packages. The separate theme packages may be organized and/or identified in a manner defined by the corresponding user in consideration of the server's capabilities. As such, the server 76 may be configured to store (e.g., in the memory device 82) a plurality of theme packages and deliver a selected one of the plurality of theme packages (e.g. the theme package 86) to the calling device 70 and/or the receiving device 72 based on instructions from a theme distributor 90 that may be included in, or otherwise in communication with, the server 76.

The theme distributor 90 may be any device or means embodied in either hardware, software, or a combination of hardware and software that is configured to manage the communication of theme information to other devices. In this regard, for example, the theme package 86 may include, in addition to the theme information, execution information defining to which device and/or under which circumstances theme information is to be communicated. For example, the theme package 86 may be stored in the memory device 82 and the execution information may define that, in response to a call being placed between the calling device 70 and the receiving device 72, the theme package 86 (or at least the theme information associated with the theme package 86) is to be streamed to the receiving device 72. Alternatively, the execution information may define that the theme package 86 is to be communicated to the receiving device 72 in a manner other than by streaming (e.g., by burst transmission), for example, at a predetermined time, at the first available opportunity, or in response to a call being placed between the calling device 70 and the receiving device 72. As another alternative, the execution information could include an identification of one or more users (e.g., one or multiple receiving devices) to which the theme package 86 or theme information should be communicated for storage at a device of the corresponding one or more users. The theme distributor 90 may be controlled by or otherwise embodied as a processing element of the server 76 to distribute or otherwise communicate the theme package 86 in response to instructions to do so or in response to the fulfillment of conditions that define a trigger for communication of the theme package 86.

The receiving device 72 may include a theme executor 92, which may be any device or means embodied in either hardware, software, or a combination of hardware and software that is configured to receive (e.g., via stream or burst) the theme package 86 (or at least the theme information associated with the theme package 86) and store or execute the theme information based, for example, on the execution information. The theme executor 92 may be controlled by or otherwise embodied as a processing element (e.g., the controller 20) of the receiving device 72. In response to receipt of the theme package 86, the theme executor 92 may be configured to store the theme information associated with the theme package 86 in the memory device 80 if there is not currently an active call between the receiving device 72 and the calling device 70. As another alternative, the receiving device 72 may itself store a received theme package 86 at the server 76 and access the theme package 86 when a call is placed between the calling device 70 and the receiving device 72. Accordingly, the theme package 86 may be stored (e.g., in the memory device 80 or 82) in association with an identification of the corresponding calling device 70 and/or receiving device 72 to enable identification of conditions requiring execution of the corresponding theme information at the receiving device 72 (e.g., when the receiving device 72 receives an active call from the calling device 70).

In an exemplary embodiment, the receiving device 72 may designate which calling devices or users may be enabled to provide a theme package to the receiving device 72. In other words, only theme packages sent from calling devices or users that are permitted by the receiving device 72 may be executed by the theme executor 92. For example, the user of the receiving device 72 may be enabled to select particular contacts from the user's contact list as individuals that are authorized to provide theme packages to the receiving device 72. Alternatively, all contacts in the contact list of the user may by default be enabled to provide theme packages to the receiving device 72. As such, theme information may be automatically received from an enabled user or device in response to receipt of a first call from the enabled user. As another example, when contact information (e.g., an electronic business card) is exchanged between devices, such an exchange of contact information may enable each device to provide theme information to the other device in order to associate incoming calls from the corresponding device with the personality of the caller as indicated by the caller defined theme provided by the corresponding caller's theme information. In an exemplary embodiment, stored theme information at a receiving device that is related to various different callers may be reviewed by selection of a corresponding link. For example, the corresponding link (or links) may be included in the contact list of the receiving device 72 in association with each corresponding contact that has provided one or more theme packages.

The theme executor 92 may be configured to execute the theme information stored in association with or otherwise received from a particular caller (e.g., the user associated with the calling device 70) in response to receipt of a call from the particular caller. The user of the receiving device 72 may define the period during which the theme information may be used to modify the theme of the receiving device 72. For example, the user of the receiving device 72 may define that the theme of the receiving device 72 may be modified according to the theme information until the call is answered, for the duration of the call, until the next call is made or received, for a predetermined period of time after the beginning or end of the call, etc. In an exemplary embodiment, if the call is not answered, the theme may be changed to indicate the last person whose call was missed. Additionally, if the device goes to a screensaver mode, a caller specific screensaver defined by the theme information may be displayed. If multiple missed calls are received over a period of time, theme information related to the missed calls could be rendered in series (e.g., in the order in which they were received) or in any suitable order. The rendering may be presented for a predetermined period of time for each caller, or may be cycled through by the receiver of the call. Alternatively, a mixture of theme information received from several missed callers may be presented. For example, a screensaver could be received from one caller and some icons may be received from another and a mix of the theme information may be rendered.

In an exemplary embodiment, the theme package 86 may only be sent to the receiving device 72 (or the server 76) one time in order to enable automatic execution of the theme information each subsequent time the calling device 70 calls the receiving device 72. However, as an alternative, the calling device 70 may communicate the theme package 86, which could be a new, modified, or the same theme package, to the receiving device 72 each time a call is made. As yet another alternative, the calling device 70, the receiving device 72 and/or the server 76 may store a plurality of theme packages associated with a particular calling device 70. As such, the calling device 70 may, instead of sending a theme package, merely identify one of the theme packages to be communicated to or executed at the receiving device 72. Thus, for example, the calling device 70 may have a separate theme package corresponding to moods such as happy, sad, excited, etc. or corresponding to events such as birthdays, special events, etc. and the calling device 70 merely identifies the theme package desired to be communicated to or executed at the receiving device 72 via mood or event information. As such, if the theme package is stored at the receiving device 72, the theme package may be executed in response to receipt of the mood or event information. Meanwhile, if the theme package is stored at the calling device 70 or the server 76, the theme package identified by the mood or event information may be communicated to the receiving device 72 for execution thereat. Updates to an existing mood package may also be provided to modify the existing mood package regardless of the storage location of the existing mood package. Such updates may be sent separately via email, or any other suitable communication mechanism, or may be provided by synchronization with a server or during a phone call or other communication session.

As indicated above, the theme information may define a user interface scheme and audio scheme that may be applicable to more than just the idle screen and background display elements. In this regard, for example, the theme information may include a caller defined shortcut key function. As such, the caller may provide the receiver of the call with a shortcut key function to, for example, synchronize the respective calendars of the caller and receiver, accept a calendar appointment, add an alarm, provide a web link, etc. The shortcut functions may only be available during the period for which the theme information is being executed.

In an exemplary embodiment, short message service (SMS) and/or multimedia messaging service (MMS) messages that are received from contacts that are enabled users with respect to providing theme information may be modified in accordance with the theme information. For example, the sender of the SMS or MMS may define different font, background images or other elements associated with rendering the corresponding SMS or MMS.

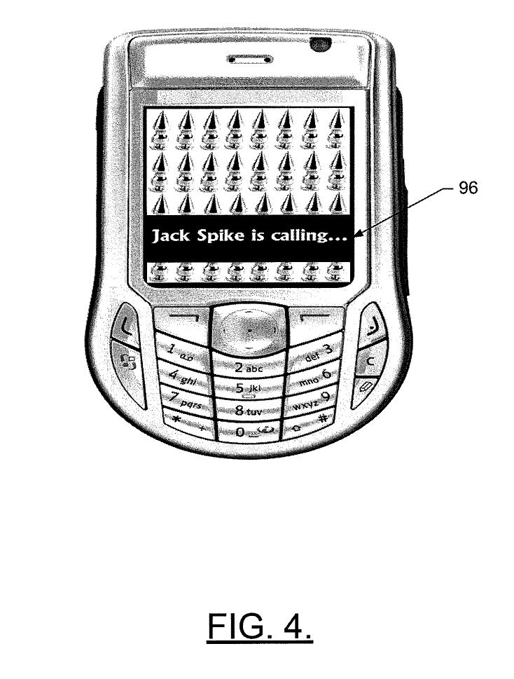

FIG. 4 illustrates an example of a display of a receiving device executing theme information provided by a calling device. As indicated in FIG. 4, the calling device of this example may be an individual named Jack Spike who has defined theme information to include a background of metallic spikes. A banner 96 may also be provided in accordance with the theme information. In this regard, the banner 96 (or another element of the user interface) may announce the caller, provide a link or other shortcut function, include a caller defined greeting, etc. In response to answering the call, the theme information could continue to impact elements of the user interface scheme and audio of the receiving device. Thus, for example, the call receiver may click on a link provided during the call and visit a website designated by the caller. However, after the call is ended, the link and other theme elements that were provided according to the caller defined theme information may be removed.

In certain instances, the caller defined theme information may not be entirely compatible with the capabilities of the receiving device 72. In such situations, one exemplary solution may be to only render those elements that are compatible with the receiving device. As an alternative, the theme executor 92 may be configured to approximate incompatible elements in a manner that avoids using unsupported capabilities. In other instances where, for example, the calling device 70 is less capable than the receiving device 72, the theme information may define display parameters that enable the receiving device 72 to emulate the calling device 70. In other words, for example, the theme information sent by the calling device 70 may enable the receiving device 72 to emulate or appear as an older, and possibly familiar, user interface scheme of the calling device 70.

Although an exemplary embodiment of the invention has been described above in the context of a caller defining theme information for the receiver of the call, other exemplary embodiments may enable a receiver of the call to alternatively or additionally define theme information for rendering at the caller's device. In this regard, for example, the calling device 70 or the server 76 may store theme information associated with the receiving device 72 and, in response to an indication of the call, the theme information may be executed at or communicated to the calling device 70. As such, the calling device 70 may also or alternatively include a theme executor and the receiving device 72 may also or alternatively include a theme definer and theme communicator.

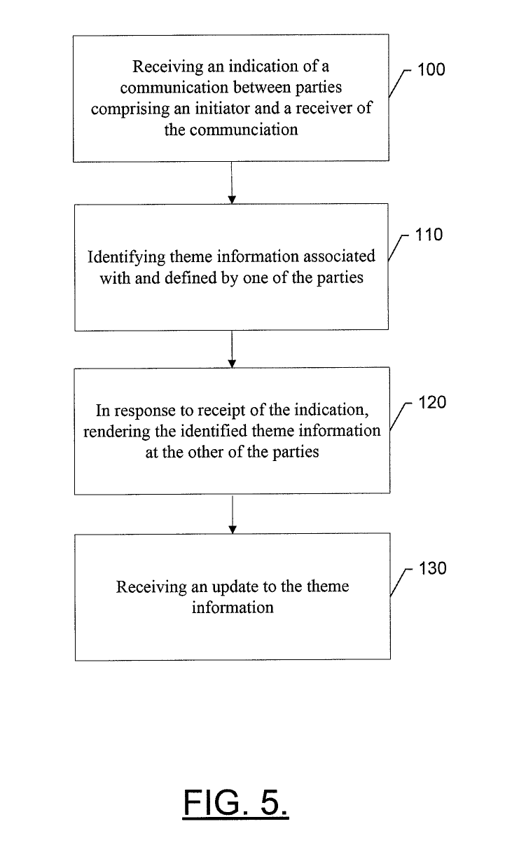

FIG. 5 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or server and executed by a built-in processor in a mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing a party defined theme as illustrated in FIG. 5 may include receiving an indication of a communication between parties including an initiator and receiver of the communication at operation 100. In an exemplary embodiment, the communication may be a phone call, a short message service (SMS) message or a multimedia messaging service (MMS) message. Theme information associated with and identified by one of the parties may be identified at operation 110. Operation 110 may include identifying initiator defined theme information as data included in the communication or identifying a storage location of the theme information and accessing the theme information from the identified storage location. The identified storage location may be one of an external location (e.g., a memory device of a network device or server) or an internal location (a memory device of the receiving or initiating device). In response to receipt of the communication, the identified theme information may be rendered at the other of the parties at operation 120. In an exemplary embodiment, operation 120 may include executing theme information comprising instructions for modifying a user interface element or an audio element associated with a device involved in the communication. An optional operation 130 may include receiving an update to the theme information.

In one exemplary embodiment, identifying theme information may include identifying initiator defined theme information and rendering the identified theme information may include rendering the identified theme information at a device of the receiver. However, in an another embodiment which may be practiced in addition to or as an alternative to the embodiment above, identifying theme information may include identifying receiver defined theme information and rendering the identified theme information may include rendering the identified theme information at a device of the initiator.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving an indication of a communication between parties comprising an initiator and a receiver of the communication;
identifying theme information associated with and defined by one of the parties; and
in response to receipt of the indication, rendering the identified theme information at the other of the parties.

2. A method according to claim 1, wherein receiving the indication comprises receiving an indication of a phone call, a short message service (SMS) message or a multimedia messaging service (MMS) message.

3. A method according to claim 1, wherein identifying the theme information comprises identifying an initiator defined theme as data included in the communication.

4. A method according to claim 1, wherein identifying the theme information comprises identifying a storage location of the theme information and accessing the theme information from the identified storage location.

5. A method according to claim 4, wherein accessing the theme information comprises accessing the theme information from the identified storage location being one of an external location or an internal location with respect to a device involved in the communication.

6. A method according to claim 1, wherein identifying the theme information comprises receiving information in the communication identifying one of a plurality of themes defined by at least one of the parties as the identified theme information.

7. A method according to claim 1, wherein rendering the identified theme comprises executing theme information comprising instructions for modifying a user interface element or an audio element associated with a device involved in the communication.

8. A method according to claim 1, further comprising receiving an update to the theme information.

9. A method according to claim 1, wherein identifying theme information comprises identifying initiator defined theme information and wherein rendering the identified theme information comprises rendering the identified theme information at a device of the receiver.

10. A method according to claim 1, wherein identifying theme information comprises identifying receiver defined theme information and wherein rendering the identified theme information comprises rendering the identified theme information at a device of the initiator.

11. A computer program product comprising at least one computer-readable storage medium having computer-readable program code portions stored therein, the computer-readable program code portions comprising:
a first executable portion for receiving an indication of a communication between parties comprising an initiator and a receiver of the communication;
a second executable portion for identifying theme information associated with and defined by one of the parties; and
a third executable portion for rendering the identified theme information at the other of the parties in response to receipt of the indication.

12. A computer program product according to claim 11, wherein the first executable portion includes instructions for receiving an indication of a phone call, a short message service (SMS) message or a multimedia messaging service (MMS) message.

13. A computer program product according to claim 11, wherein the second executable portion includes instructions for identifying an initiator defined theme as data included in the communication.

14. A computer program product according to claim 11, wherein the second executable portion includes instructions for identifying a storage location of the theme information and accessing the theme information from the identified storage location.

15. A computer program product according to claim 14, wherein the second executable portion includes instructions for accessing the theme information from the identified storage location being one of an external location or an internal location with respect to a device involved in the communication.

16. A computer program product according to claim 11, wherein the second executable portion includes instructions for receiving information in the communication identifying one of a plurality of themes defined by at least one of the parties as the identified theme information.

17. A computer program product according to claim 11, wherein the third executable portion includes instructions for executing theme information comprising instructions for modifying a user interface element or an audio element associated with a device involved in the communication.

18. A computer program product according to claim 11, further comprising a fourth executable portion for receiving an update to the theme information.

19. A computer program product according to claim 11, wherein the second executable portion includes instructions for identifying initiator defined theme information and wherein the third executable portion includes instructions for rendering the identified theme information at a device of the receiver.

20. A computer program product according to claim 11, wherein the second executable portion includes instructions for identifying receiver defined theme information and wherein the third executable portion includes instructions for rendering the identified theme information at a device of the initiator.

21. An apparatus comprising a processing element configured to:
receive an indication of a communication between parties comprising an initiator and a receiver of the communication;
identify theme information associated with and defined by one of the parties; and
render the identified theme information at the other of the parties in response to receipt of the indication.

22. An apparatus according to claim 21, wherein the processing element is further configured to receive an indication of a phone call, a short message service (SMS) message or a multimedia messaging service (MMS) message.

23. An apparatus according to claim 21, wherein the processing element is further configured to identify an initiator defined theme as data included in the communication.

24. An apparatus according to claim 21, wherein the processing element is further configured to identify a storage location of the theme information and access the theme information from the identified storage location.

25. An apparatus according to claim 24, wherein the processing element is further configured to access the theme information from the identified storage location being one of an external location or an internal location with respect to a device involved in the communication.

26. An apparatus according to claim 21, wherein the processing element is further configured to receive information in the communication identifying one of a plurality of themes defined by at least one of the parties as the identified theme information.

27. An apparatus according to claim 21, wherein the processing element is further configured to execute theme information comprising instructions for modifying a user interface element or an audio element associated with a device involved in the communication.

28. An apparatus according to claim 21, wherein the processing element is further configured to receive an update to the theme information.

29. An apparatus according to claim 21, wherein the processing element is further configured to identify initiator defined theme information and to render the identified theme information at a device of the receiver.

30. An apparatus according to claim 21, wherein the processing element is further configured to identify receiver defined theme information and to render the identified theme information at a device of the initiator.

31. An apparatus comprising:
means for receiving an indication of a communication between parties comprising an initiator and a receiver of the communication;
means for identifying theme information associated with and defined by one of the parties; and
means for rendering the identified theme at the other of the parties in response to receipt of the indication.

32. An apparatus according to claim 25, further comprising means for executing theme information configured to execute instructions for modifying user interface elements or audio elements associated with a device involved in the communication.
